(19) United States
(12) Patent Application Publication
(10) Pub. No.: US 2002/0040310 A1
(43) Pub. Date: Apr. 4, 2002

(54) Method of tracking participants'behavior in a computerized dating or matchmaking service to determine underlying feature preferences that are used to rank matches based on level of compatibility

(76) Inventors: Aaron Lieben, Santa Cruz, CA (US); David Sals, Santa Cruz, CA (US)

Correspondence Address: Jeffrey Hall, 212 Clinton Street, Santa Cruz, CA, 95062, US

(21) Appl. No.: 09/954,931

(22) Filed: Sep. 17, 2001

Related U.S. Application Data
(60) Provisional application No. 60/237,546, filed on Sep. 30, 2000.

(51) Int. Cl. G06F 17/60

(52) U.S. Cl. 705/7

(57) ABSTRACT

A method of tracking participants' behavior in a computerized dating or matchmaking service to determine selection preferences that are utilized to rank matches with other participants based on level of compatibility, comprising; creating personal profiles by a first and a second participant; selecting or rejecting the second participant for communication by the first participant; and calculating a compatibility score between the first participant and the second participant and/or a plurality of other participant's by comparing the first participants' statistics as determined by choices made by the first participant with the second participant and/or the plurality of other participants.

### BACKGROUND OF THE INVENTION

1. Field of Invention

This invention relates to methods of providing an ordered list of matches for a participant in a computerized dating or matchmaking service, based on identification of the participant's preferred qualities for compatibility through observation of the participant's behavior and choices while using the service.

2. Description of the Related Art

Numerous methods and strategies have been developed through history for matching people for marriage, dating and friendship. In many cultures, the matchmaker has been and still is an integral and accepted means to meet others for marriage and companionship.

In contemporary society, cultural and demographic changes have made it increasingly difficult for individuals to meet and date other like-minded individuals. This is so due to factors such as increased work hours, increased condemnation of relationships in the workplace and changes in family and social structures.

Many services associated with introducing people to each other have been developed to meet this need for example, dating services, personal ads in newspapers or on the Internet, computerized dating services, and the like.

The common methodology employed by all of these services involves a subscriber providing personal data to the service, which includes biographic and demographic information about themselves as well as general biographic and demographic information describing the type of person they want to be matched with.

Computerized dating and matchmaking services commonly further this methodology by then providing the subscriber with a list of matches from simply cross-matching all of this information. A score may or may not be associated with each match on your list.

This methodology not only assumes that the subscriber knows exactly what he or she is looking for in another person, but it also assumes that the subscriber knows how to rank these qualities in precisely the right order, if the qualities are ranked at all, often all qualities are given equal weight. Further, once this list of qualities and ranking of qualities is set, the subscriber must manually make adjustments to this biographic and demographic information in order to produce different match results.

Another common methodology is that the participant will make choices of who they want to contact from the list of matches available to them. Participants may also be contacted by other participants, and then must choose whether or not they want to continue a correspondence. There is no observation made by the system of these choices made by its participants, and therefore no scoring adjustments can be made to better reflect the subscriber's preferences.

By observing the participants' behavior in who they choose, information can be stored by a computerized dating system in order to learn about the individual making the choices. The system can then intelligently and intuitively assist the individual to more efficiently meet those subscribers whom they want to meet, and to avoid those whom they are not interested in meeting.

Through continual observation of the participants choices, the system can build a list of matches for that participant which is flexible in that it is continually self-correcting and regenerating in order to best fit the participant's needs. At any point in time, the resulting list of matches incorporates and reflects all of the past history of that participant's choices.

One significant benefit of using observation to generate a ranking of a participant's matches, is that it saves the trouble and difficulty of the person having to list and rank every single quality that they are looking for.

A second benefit of an observant scoring system is that it properly reflects the mutable nature of compatibility. Perhaps the participant isn't sure what they're looking for. The participant may have some subconscious agenda that he or she is not aware of, or may simply changes his or her mind as times goes on. Clearly, there is a tremendous advantage to enabling the computerized dating system to identify and adapt to a participant's changing needs and desires.

A third benefit of an observant scoring system is that each participant can learn from the observations made by the system. A list of the traits that have been favored by a participant's selection and/or rejection of other subscribers, and the degree of favor each trait has received, can be made available to that participant. This list provides a participant with feedback about his or her selection behavior as well as knowledge that the system is doing its part to find that participant the best possible match based not only on the biographic and demographic information provided, but also on his or her actual choices.

Accordingly, it is the primary purpose of this invention to observe the selection and/or rejection behavior of the participants of an Internet dating service and then utilize that information to calculate compatibility scores between all matching participants of the service.

Additional objects and advantages of the invention will be set forth in the description that follows, and in part will be obvious from the description, or may be learned by practice of the invention. The objects and advantages of the invention may be realized and obtained by means of the instrumentalities and combinations particularly pointed out in the appended claims.

### BRIEF SUMMARY OF THE INVENTION

This invention provides a method for observing, matching and ranking potential dating partners within a computerized dating or matchmaking service. The method includes tracking participants' behavior in a computerized dating or matchmaking service to determine selection preferences that are utilized to rank matches with other participants based on level of compatibility. The method may be used in an Internet dating service, computer dating service, or other matchmaking services by creating personal profiles by a first and a second participant; selecting or rejecting the second participant for communication by the first participant; and calculating a compatibility score between the first participant and the second participant and/or a plurality of other participant's by comparing the first participants' statistics as determined by choices made by the first participant with the second participant and/or the plurality of other participants.

The methodology of this invention may also be used in other matching or matchmaking activities such as:

Matching professional services with clients, and vice versa: The invention could rank potential service providers (such as doctors, lawyers, realtors, investment advisors, etc.), for someone seeking the service, or could help a professional service provider identify an ideal client by ranking prospects.

Matching potential employers and employees: same as above.

Ranking products and services: based on observation of what features a buyer tends to favor in a television set, book, CD, massage therapist or any other product or service, the system could rank all available products or services from most to least preferable, or make purchase recommendations.

Helping users to find business partners, activity partners, housemates, friends, etc., and providing movie and restaurant recommendations and selection services.

### DETAILED DESCRIPTION OF THE INVENTION

Reference will now be made in detail to the present preferred embodiments of the invention as illustrated in the accompanying drawings.

For clarity and understanding of the disclosed methodology the following definitions apply throughout the disclosure and are descriptive for elements of the preferred and alternate embodiments.

Definition of a Match: Two participants are considered a match when the first participant meets all requirements for compatibility indicated by the second participant, and the second participant meets all requirements for compatibility indicated by the first participant, or when a single participant indicates a match choice.

Ranking of a Match: Matches can be ranked by degree of compatibility, as is determined by the requirements for compatibility set forth by both participants and further determined by observation of the behaviors and choices of both participants using the service.

Definition of Contact: A participant initiates contact with another participant via email or within the service. Initiating contact is considered to be a selection by indication of interest and is observed as such. For the purposes of this invention, this contact may also include a section that prompts the second participant to indicate interest or non-interest in the first participant. The first participant may receive a notification of this interest via email. The first participant may also receive a notification when he or she next signs on to the dating service.

In accordance with the present invention there is provided a method of tracking participants' behavior in a computerized dating or matchmaking service, such as an Internet dating service, to determine selection preferences that are utilized to rank matches with other participants based on level of compatibility, comprising; creating personal profiles by a first and a second participant; selecting or rejecting or expressing an interest in the second participant for communication by the first participant; and calculating a compatibility score between the first participant and the second participant and/or a plurality of other participant's by comparing the first participants' statistics as determined by choices made by the first participant with the second participant and/or the plurality of other participants.

The present methodology preferably includes the following steps:

1. Each participant fills out a personal profile consisting of biographic and demographic information about him or herself. He or she may also provide general biographic and demographic information describing the type of person he/she wants to be matched with.

2. A scoring weight is calculated for each question in the participant's individual profile. This scoring weight may be based on the biographic and demographic information provided. It may also be set initially to a previously determined default value.

3. A match score for each question is calculated between participants:

3a. The first participant's match history or talley for each question may be compared with the second participant's response to the same question, the result being used to calculate the match score. Alternatively, the first participant's response to the question may be compared with the second participant's response to the question, the result being used to calculate the score.

3b. The resulting match score for the question reflects both the results of the comparison and also the scoring weights of each participant for that question.

3c. The system may store a single match score for both participants for that question. Alternatively, the system may store a separate match score for each participant for each question, and then combine these two scores to arrive at the match score for both participants for that question.

3d. A total match score for the two participants is then calculated by adding the match scores for both participants of all of the individual questions.

4. A first participant views a second participant's profile, or receives contact from said second participant, and indicates that he or she is interested in said second participant:

4a. The first participant may indicate interest while viewing the second participant's profile on the computerized matchmaking system. The second participant may receive a notification of this interest via email. The second participant may also receive a notification when he or she next signs on to the dating service.

4b. The first participant may indicate interest when prompted to respond interested or not interested to an initial contact from the second participant. The second participant may receive a notification of this interest via email. The second participant may also receive a notification when he or she next signs on to the dating service.

4c. If the first participant chooses to initiate contact with the second participant, via email or within the service, this is considered to be an indication of interest and is observed as such.

4d. If the first participant chooses to respond, via email or within the service, to contact initiated by the second participant, this is considered to be an indication of interest and is observed as such.

4e. The first participant's indication is observed and the scoring weights of the first participant for each question are increased to reflect the second participant's response to the same question.

4f. The first participant's scoring weights are stored in the system.

4g. The system may also store a tally for the first participant for each possible response to each question, and may increase the tally for responses that match those made by the second participant for those same questions.

5. Alternatively, a first participant views a second participant's profile, or receives contact from said second participant by email or other means, and indicates that he or she is not interested in said second participant:

5a. The first participant may indicate non-interest or rejection while viewing the second participant's profile on the computerized matchmaking system. The second participant may receive a notification of this non-interest via email. The second participant may also receive a notification when he or she next signs on to the computerized dating service, or when he or she next attempts to view said first participant's profile.

5b. The first participant may indicate non-interest when prompted to respond interested or not interested to an initial contact from the second participant. The second participant may receive a notification of this non-interest via email. The second participant may also receive a notification when he or she next signs on to the computerized dating service, or when he or she next attempts to view said first participant's profile.

5c. The first participant's indication is observed and the scoring weights of the first participant for each question are decreased to reflect the second participant's response to the same question.

5d. The first participant's scoring weights are stored in the system.

5e. The system may also store a tally for the first participant for each possible response to each question, and may decrease the tally for responses that match those made by the second participant for those same questions.

6. The total match scores between participants are periodically recalculated:

6a. Recalculation may take place on a scheduled basis.

6b. Recalculation may take place whenever the scores are displayed.

6c. Recalculation may take place based on the occurrence of one or more other frequently occurring events.

7. A list of responses to each question, showing the degree of favor each response has received, is made available to that participant:

7a. Favor is determined by the tally of a participant's selection and/or rejection of other subscribers, using the methods described above (4g, 5e).

7b. This list may include all question responses ordered by degree of favor. Alternatively, the list may highlight only particularly favored and/or particularly unfavored responses.

Preferably, compatibility score is created by comparing a first person's statistics with the other participant's profile answers and then comparing the other participant's statistics with the first person's profile answers. Statistics are tracked by keeping a tally of all possible answers that can appear in a profile and then increasing them when an answer matches the profile of a selected person or decreasing them when an answer matches the profile of a rejected person. Selection happens when one participant chooses to contact another, or when a participant is contacted by another participant and responded ‘yes’. Rejection happens when a participant indicates that he or she is not interested in corresponding. This can happen when looking at a list of prospects, an individual profile, or when a participant receives and introduction or communication.

In the preferred set-up and initialization when a new user signs onto the computerized dating service, he or she answers several multiple-choice questions. An example question might be, “What is your religion,” with possible answers being Catholic, Jewish, Mormon, etc. Each answer given by the user is stored in their personal profile. Some questions will offer the option of responding “any or all of the above.”

The user's response to each question is stored in the user's personal profile. The system stores these responses by setting up a tally. That is, a number is stored for each possible answer to each multiple-choice question. Initially, each response NOT selected by the user to a question is tallied as a negative 5 (this number is arbitrary, and merely serves as a starting point). The selected response is given a positive tally that exactly balances the sum of the tallies for the non-selected answers. For example, if there are four answers, each of the three non-selected answers is tallied as negative 5, and the selected response is tallied as positive 15 (3 times 5). At all times, the total tally for all answers to a question equals zero, because the positive tallies exactly balance the negative tallies.

The user may also be asked to indicate what he or she is looking for in another person, by answering the same questions from that perspective. These responses are tallied using the same method described in the previous paragraph.

At the completion of the sign-up procedure, the new user has a profile which contains his or her responses to all of the multiple choice questions. The profile may also include photographs, video, and/or audio files, as well as responses to non-multiple-choice questions. In this implementation, only the multiple-choice responses are used for the purposes of observation and ranking of matches.

All users who sign onto the service must first go through the above procedure, and therefore each user of the service, after signing on for the first time will have a personal profile wherein are stored all of his or her responses to the same questions.

When a user of the service wishes to view all of his or her matches, a score is calculated between the user and each match, representing the degree of compatibility for that particular match, and then the matches may be ranked in descending order based on their match scores. Each Score may reflect the observations made on both parties. For example, the score will represent the history of your behavior and the history of the other person s behavior combined. The assumption is that compatibility is a two-way system, and what each person is looking for needs to be taken into account.

The observation of a user's choices preferably comprise when a first user indicates interest or non-interest in a second user, this indication is observed, and adjustments are made to the first user's values as follows:

When the first user indicates interest: for every multiple-choice question in the first user s profile, the tally column is increased that corresponds with the response given to that question by the second user. This tally is increased one unit for each other response to that question. For example, if the second user chooses the “Catholic” response to the religion question and there are 10 possible answers, the tally stored for “Catholic” in the religion question in the first user's profile is increased by 9 units. All other columns for that question in the first user's profile are decreased by one unit so that the sum of all tallies for that question continues to equal zero.

When the first user indicates non-interest: for every multiple-choice question in the first user's profile, the tally column that corresponds with the response given to that question by the second user is decreased in the same manner. For example, if the second users chooses the “Catholic” response to the above religion question, the tally stored for “Catholic” in the religion question in the first user's profile is decreased by 9 units. All other columns for that question in the first user's profile are increased by one unit so that the sum of all tallies for that question continues to equal zero.

An indication of interest or non-interest is considered an observed event. When either of these events take place, ‘Observation’ is increased by one, and the new number is stored in the first user's profile.

The above process may take place the first time a first user indicates interest or non-interest in a second user, or it may happen every time the first user indicates interest or non-interest in this second user. Alternatively, it may occur on an intermittent basis.

Indication of interest or non-interest can take place in a variety of ways. Some examples include:

Viewing the second user's profile on the service, and selecting an “interested” or “not interested” option at that location.

Sending the second user an email, or contacting him or her through the service. This is considered an indication of interest.

Responding to an initial contact via email or through the service from the second user. In this case, the option can be presented, when this initial contact is delivered, to select “interested” or “not interested”. If no option to indicate “not interested” is presented, or if the option is presented but not selected, responding to the initial contact will be considered an indication of interest.

In the preferred methodology a match score is calculated between two members in the following way:

First, a match score is generated for each individual question as follows:

The first user's tally column for the question, corresponding with the second user's response to the same question, is pulled. In other words, the number stored in the first user's profile which represents that same response is located. For example, if the question is “do you smoke,” and the second user's response is “no” from possible responses of “yes, no, sometimes,” the “no” column for the smoking question is referenced in the first user's profile. In this example, suppose the first user has the following values stored for that question: yes=-10, no=7, sometimes=3. The number 7 is pulled for the second user's “no” response. We'll reference this first number as ‘tally’.

Then, ‘tally’ is multiplied by the number of possible responses to the question. In the smoking question example above, there are 3possible responses (yes, no, sometimes). for example, this number may be referred to as ‘possibilities’. This resulting product is divided by the sum of the first user's positive tallies for that question. In this example, the positive tallies (7 and 3) add up to 10. This is called the ‘tally range’.

The equation for calculating the match score for each question for the first user, therefore, is ‘tally’ times ‘possibilities’ divided by ‘tally range’

Once the first user's match score for this question is calculated, the second user's match score is calculated for the same question, by following the above steps and switching the roles of the first and second user.

After both users' match scores have been calculated for this question, the two match scores are added, this being the combined match score for this question for these two users.

The combined match scores for these users for all questions are added to find the total match score for the match that consists of these two users.

In operation and use when viewing their respective match lists, the first user and the second user preferably will both show the same total match score for this match between these two users. The match score may be represented as a number. It may also be represented as a percentage of an ideal score. It may also be represented as a “rating” (e.g. “4 of 5 stars,” or “Excellent”).

Users can view all of their matches ranked in descending order by score from most compatible to least compatible.

Users can also see how well the system is tracking their choices by selecting to view their question response tallies. After selecting this option, the user might see each question with a list of the possible responses numbers or graphs representing the current tallies for each response.

Alternatively, the user could just be shown the response for each question with the highest current tally, or just the responses for each question which have better-than-average tallies.

Accordingly, present invention provides a method which allows a user or other member of a computerized dating service to keep track of preferences for other members profile answers by updating personal statistics every time the user either rejects or selects another member for communication. The statistics are used as a weighting mechanism for calculating a compatibility score between the user and another participant. Unique and novel advantages of the present invention include:

1. Participants may not know what they're looking for, might be wrong about what they think they're looking for, or might change their mind about what they're looking for. The invention learns and figures it out based on observations of their choices and actions. This creates a highly flexible, adaptable, and intelligent ranking system.

2. Because the observations and adjustments happen to everyone using the service, participants benefit from the invention from the moment they join the service. Even without making any choices him or herself, a participant will see his or her matches ranked more accurately than if the invention were not being used, because the choice history of everyone he or she is matched with is also being taken into account (if this invention were used to give book recommendations, each book, though unable to itself make choices, could have a feature tally history of the people who have purchased it in the past). The assumption is that compatibility is a two way system, and what each person is looking for needs to be taken into account.

3. Observation of participant behavior and corresponding adjustments to the match rankings are made in the background, without any burden to the participant. The participant simply decides who he or she is and is not interested in.

4. By looking at the list of favored responses, participants can learn about the choices they are making. This helps participants to learn about themselves and their goals by seeing their own behavior patterns.

5. The invention gives participants confidence that the longer they participate, the better their results will be. The system provides an invisible hand to participants over time, to make it easier and easier to find the right match.

6. The invention relieves participants of some of the burden of identifying what they are looking for, thus making it easier for the participants to fill out their personal profiles.

7. Even if a user doesn't make contact with anybody, the system still figures out compatibility for that person. It observes this person's actions of non-interest in other members. It also uses the information from other members to create a compatibility score for that person.

As is evident from the above description, a wide variety of data tracking applications and systems may be envisioned from the disclosure provided. The methodology described herein is applicable in any data processing system and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A method of tracking participants' behavior in a computerized dating or matchmaking service to determine selection preferences that are utilized to rank matches with other participants based on level of compatibility, comprising:
creating personal profiles by a first and a second participant;
selecting, rejecting or expressing interest in said second participant for communication by said first participant; and
calculating a compatibility score between said first participant and said second participant and/or a plurality of other participant's by comparing said first participants' statistics as determined by choices made by said first participant with said second participant and/or said plurality of other participants:

2. The method of claim 1, wherein a scoring weight is calculated for each answer given to a question in a participants' individual profile.

3. The method of claim 1, wherein a match score is calculated between said first participant and said second participant.

4. The method of claim 1, wherein a match score is calculated between said first participant and said plurality of other participants.

5. The method of claim 1, wherein statistics of a participant are updated every time he or she rejects or selects another participant for communication.

6. A method for creating a compatibility score between participants in a computerized dating service; comprising,
comparing a first person's statistics with other participants'profile answers and then comparing said other participants'statistics with said first person's profile answers;
tracking statistics by keeping a tally of all possible answers that can appear in a profile and then increasing them when an answer matches the profile of a selected person or decreasing them when an answer matches the profile of a rejected person; and
selecting a participant to communicate with, when one participant chooses to contact another or, when a participant is contacted by another participant and respondeds ‘yes’; or rejecting said participant to communicate with, when a participant indicates that he or she is not interested in corresponding.

7. The method of claim 6, wherein said selecting a participant to communicate with is determined by looking at a list of prospects, an individual profile, or when a participant receives and introduction or communication.

8. The method of claim 6, wherein a scoring weight is calculated for each answer given to a question in a participants' individual profile.

9. The method of claim 6, wherein a match score is calculated between said first participant and said second participant.

10. The method of claim 6, wherein a match score is calculated between said first participant and said plurality of other participants.

11. The method of claim 6, wherein statistics of a participant are updated every time he or she rejects or selects another participant for communication.

12. A method utilizing the selection and/or rejection behavior of participants of a matchmaking service to calculate compatibility scores between all matching participants of the service, comprising:
comparing a first person's statistics with a second participants' profile answers and then comparing said second participants' statistics with said first person's profile answers;
tracking statistics by keeping a tally of possible answers that can appear in a profile and then increasing them when an answer matches the profile of a selected person or decreasing them when an answer matches the profile of a rejected person; and
selecting a participant to communicate with, when one participant chooses to contact another or when a participant is contacted by another participant and responded ‘yes’; or rejecting said participant to communicate with, when a participant indicates that he or she is not interested in corresponding.
